(19) United States
(12) Patent Application Publication
(10) Pub. No.: US 2019/0137841 A1
(43) Pub. Date: May 9, 2019

(54) ELECTROCHROMIC DEVICE AND ELECTROCHORMIC SYSTEM

(71) Applicant: LG ELECTRONICS INC., Seoul (KR)

(72) Inventors: Sangmo KOO, Seoul (KR); Munheon HONG, Seoul (KR); Chilkeun PARK, Seoul (KR)

(73) Assignee: LG ELECTRONICS INC., Seoul (KR)

(21) Appl. No.: 16/091,346

(22) PCT Filed: Nov. 4, 2016
(86) PCT No.: PCT/KR2016/012651

§ 371 Date: Oct. 4, 2018

(30) Foreign Application Priority Data
Apr. 8, 2016 (KR) 10-2016-0043619
May 26, 2016 (KR) 10-2016-0064980

(51) Int. Cl. G02F 1/163; G02F 1/155; B60J 3/04

(52) U.S. Cl. CPC G02F 1/163; B60J 3/04; G02F 1/155

(57) ABSTRACT

The present invention relates to an electrochromic device having an improved color changing speed. The present invention provides an electrochromic device comprising: a first transparent electrode; a second transparent electrode facing the first transparent electrode; a first bus electrode of a predetermined pattern formed on an upper surface of the first transparent electrode; an electrolyte layer positioned between the first bus electrode and the second transparent electrode; a first electrochromic layer positioned between the first transparent electrode and the electrolyte layer and coming in contact with the electrolyte layer; and a passivation layer formed between the first bus electrode and the electrochromic layer so as to prevent contact of the first bus electrode and the electrochromic layer, and encompassing the first bus electrode. According to the present invention, the electrochromic speed of a large area electrochromic device can be improved.

### TECHNICAL FIELD

The present invention relates to an electrochromic device having an improved color changing speed, and an electrochromic system capable of adjusting an amount of light incident through car windows.

### BACKGROUND ART

Electrochromism is a phenomenon in which coloration or decolorization is performed by electrochemical oxidation or reduction reaction depending on the direction of application of electric current. An electrochromic material maintains a predetermined color, and when electric current is applied, the electrochromic material will be discolored to another color. And, when the direction of the electric current is reversed, the original color of the electrochromic material is restored.

Here, the absorption spectrum of the electrochromic material is changed by oxidation or reduction reaction. That is, the electrochromic material does not emit light by itself, but takes color through light absorption. Electrochromic devices having such properties have been widely used for uses such as mirrors and sunroofs for vehicles, smart windows, and outdoor displays.

An electrochromic device is formed of a substrate and an electrode, an electrochromic material, an electrolyte, and again an electrode and a substrate, and may reversibly change the color of the device depending on the voltage applied thereto.

The electrochromic may be implemented in various areas according to the use thereof. When the area of the electrochromic device is increased, the color changing speed of the electrochromic device is lowered because electric charge is disproportionately supplied to the electrochromic material.

Meanwhile, in order to prevent a driver from being glared, a light shielding film is attached to car windows. Since the light shielding film has a fixed light transmittance, the light shielding film effectively blocks external light when the outside of a vehicle is bright, but makes it difficult to secure the visual field of a driver when the outside of the vehicle is dark.

In order to solve such these problems, there is an increasing demand for a smart window capable of adjusting the light shielding capability of a car window according to external light. Meanwhile, since the smart windows in the related art collectively and uniformly adjust the light transmittance of the entire car window according to external light, there has been a problem in that the smart windows obstruct the visual field for the dark portion.

### DISCLOSURE OF THE INVENTION

An object of the present invention is to solve the above-described problems and other problems. Another object is to provide an electrochromic device having a fast color changing speed even though the reaction area is increased.

Still another object of the present invention is to provide an electrochromic device which minimizes heterogeneity generated by a bus electrode included in an electrochromic device.

Yet another object of the present invention is to provide an electrochromic system which selectively changes the light transmittance of a part of a car window according to the amount of light passing through the car window.

To achieve these and other advantages and in accordance with the purpose of the present invention, as embodied and broadly described herein, there is provided an electrochromic device comprising: a first transparent electrode; a second transparent electrode facing the first transparent electrode; a first bus electrode of a predetermined pattern formed on an upper surface of the first transparent electrode; an electrolyte layer positioned between the first bus electrode and the second transparent electrode; a first electrochromic layer positioned between the first transparent electrode and the electrolyte layer and coming in contact with the electrolyte layer; and a passivation layer formed between the first bus electrode and the electrochromic layer so as to prevent contact of the first bus electrode and the electrochromic layer, and encompassing the first bus electrode.

In an Example, the passivation layer may be formed of an insulating material, and the insulating material may be any one of SiO₂ and TiO₂. Through this, it is possible to prevent corrosion of the first bus electrode and to prevent the first bus electrode from shining.

In an Example, the first bus electrode may be any one of a metal, a conductive polymer, and a conductive carbon nanotube. Through this, electric charge may be rapidly supplied to the electrochromic layer.

In an Example, the passivation layer may be formed between the first transparent electrode and the first electrochromic layer so as to prevent contact of the first transparent electrode and the first electrochromic layer. In this case, the passivation layer may be formed of a conductive material.

In an Example, the electrochromic device according to the present invention may further include an ion storage layer between the electrolyte layer and the second transparent electrode.

Further, according to an aspect of the present invention, the present invention provides an electrochromic device driving system including an electrochromic unit which is composed of an electrochromic device and configured so as to change the light transmittance for at least a partial region, a sensing unit which is configured so as to sense an amount of light incident to the electrochromic unit, and a control unit which controls the electrochromic unit such that when the amount of light incident through a partial region of the electrochromic unit is changed, the light transmittance for the partial region is changed.

In an Example, the electrochromic unit is characterized by including a plurality of electrodes, and the control unit may control a voltage value applied to each of the plurality of electrodes such that the light transmittance of the partial region is changed. Through this, the present invention may change the light transmittance of a part of a car window.

In an Example, the control unit may control the electrochromic unit such that when the amount of light incident through the partial region becomes larger than the reference value, the light transmittance of the partial region is decreased. Through this, the present invention may prevent a driver from feeling difficulty in securing the visual field caused by external light.

In an Example, the control unit may control the electrochromic unit such that when the amount of light incident through the partial region becomes smaller than the reference value, the light transmittance of the partial region is increased. Through this, the present invention enables a driver to easily secure the visual field even though a vehicle enters a dark place.

In an Example, the electrochromic device may include a first transparent electrode, an electrochromic layer formed on the first transparent electrode and formed of an electrochromic material, an electrolyte layer formed on the electrochromic layer, a second transparent electrode formed on the electrolyte layer, a plurality of first bus electrodes formed between the first transparent electrode and the electrochromic layer, a first passivation layer encompassing each of the first bus electrodes, a plurality of second bus electrodes formed between the electrolyte layer and the second transparent electrode, and a second passivation layer encompassing each of the second bus electrodes.

In an Example, the electrochromic device driving system further includes a power supply unit, in which the control unit may control the electrochromic unit such that when power supplied from the power supply unit is interrupted, all the regions of the electrochromic layer become a first state. Through this, present invention enables a driver to secure the visual field even when power supplied to the system is interrupted due to an accident, and the like.

According to the present invention, the electrochromic speed of a large area electrochromic device can be improved.

Further, according to the present invention, as the electrochromic device is driven for a long period of time, it is possible to prevent the bus electrode included in the electrochromic device from being oxidized.

In addition, according to the present invention, by the bus electrode included in the electrochromic device, it is possible to prevent a user from feeling heterogeneity.

Meanwhile, the electrochromic system according to an Example of the present invention may prevent a driver from being glared and simultaneously enable the driver to easily secure the visual field for the dark place by blocking an amount of external light incident through a car window.

### BRIEF DESCRIPTION OF THE DRAWINGS

FIG. 1 is a cross-sectional view of an electrochromic device according to an Example of the present invention;

FIG. 2 is a cross-sectional view illustrating an electrochromic device including a passivation layer configured so as to prevent contact of a transparent electrode and an electrochromic layer;

FIG. 3 is a cross-sectional view illustrating an electrochromic device including an ion storage layer;

FIGS. 4A and 4B are cross-sectional views illustrating an electrochromic device including an ion storage layer and a plurality of passivation layers;

FIGS. 5A and 5B are cross-sectional views illustrating an electrochromic device including a plurality of electrochromic layers;

FIG. 6 is a cross-sectional view illustrating an electrochromic device including a passivation layer formed so as to prevent contact of a transparent electrode and a bus electrode;

FIGS. 7A and 7B are cross-sectional views illustrating an electrochromic device having an irregularity structure;

FIG. 8 is a cross-sectional view illustrating an electrochromic device including a bus electrode formed of spherical nanoparticles;

FIG. 9 is a cross-sectional view illustrating an electrochromic device including a bus electrode forming a partition wall;

FIG. 10 is a cross-sectional view illustrating an electrochromic device including a bus electrode formed of a mixture of metal and conductive ink;

FIGS. 11A to 11C are cross-sectional views illustrating an electrochromic device including a barrier layer and a hard coating layer;

FIGS. 12 and 13 are conceptual views illustrating a pattern of a bus electrode included in the electrochromic device according to the present invention;

FIG. 14 is a perspective view illustrating an electrochromic device according to an Example of the present invention;

FIG. 15 is a cross-sectional view taken along line B-B of FIG. 14;

FIG. 16 is a cross-sectional view taken along line C-C of FIG. 14;

FIG. 17 is a cross-sectional view of an electrochromic device which does not include a passivation layer;

FIGS. 18A to 18C are cross-sectional views of an electrochromic device including a bonding layer;

FIGS. 19A to 19D are conceptual views illustrating a pattern of a bus electrode included in the electrochromic device according to the present invention;

FIG. 20 is a conceptual view illustrating a change in light transmittance of the electrochromic device according to the present invention;

FIG. 21 is a conceptual view illustrating an electrochromic device in which bus electrodes are irregularly disposed;

FIG. 22 is a conceptual view illustrating the position of a sensor unit inside a vehicle;

FIG. 23 is a block diagram of an electrochromic system according to an Example of the present invention; and

FIG. 24 is a conceptual view illustrating an electrochromic system according to an Example of the present invention.

### MODES FOR CARRYING OUT THE PREFERRED EMBODIMENTS

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Description will now be given in detail of a drain device and a refrigerator having the same according to an embodiment, with reference to the accompanying drawings.

Hereinafter, Examples disclosed in the present specification will be described in detail with reference to the accompanying drawings, the same reference numerals are given to the same or similar constituent elements irrespective of the drawing signs, and the repeated description thereof will be omitted. When it is determined that the detailed description of the publicly known art related in describing the Examples disclosed in the present specification may obscure the gist of the Examples disclosed in the present specification, the detailed description thereof will be omitted. In addition, the accompanying drawings are provided to easily understand the examples disclosed in the present specification, and it is to be appreciated that the technical spirit disclosed in the present specification is not limited by the accompanying drawings, and the accompanying drawings include all the modifications, equivalents, and substitutions included in the spirit and the technical scope of the present invention.

Hereinafter, an electrochromic device according to an Example of the present invention will be described with reference to the accompanying drawings.

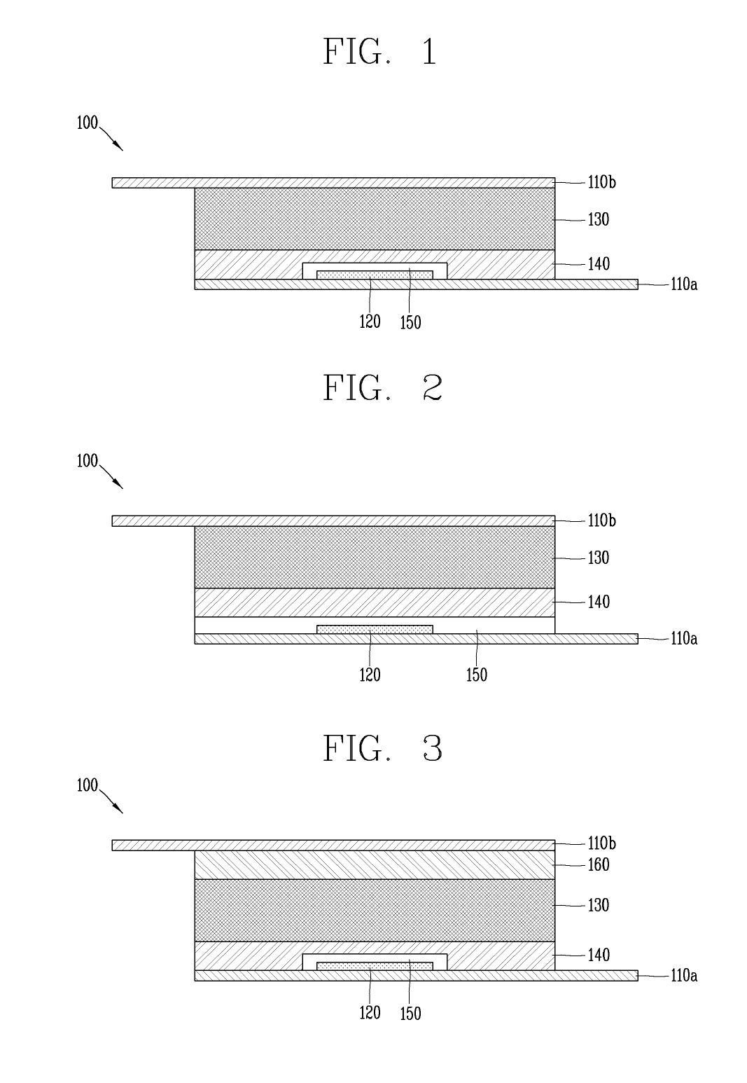

FIG. 1 is a cross-sectional view of an electrochromic device according to an Example of the present invention.

The electrochromic device according to an Example of the present invention includes a plurality of constituent elements between a first transparent electrode and a second transparent electrode facing the first transparent electrode. Hereinafter, a transparent electrode and constituent elements included between the two transparent electrodes will be described in detail with reference to FIG. 1.

The first and second transparent electrodes are electrodes having optical transparency and conductivity. The transparent electrode may be formed on a substrate formed of glass or a light-transmitting film, and may be a thin film formed of tin oxide, indium oxide, platinum, and gold, or a thin film formed of a conductive polymer.

The transparent electrode is used to apply voltage to an electrochromic material, and a power supply device is connected to one end of the transparent electrode. The power supply device generates a potential difference between two transparent electrodes facing each other. However, in the electrochromic device according to an Example of the present invention, the power supply device may not be connected to the transparent electrode, and the power supply device may be connected to only a bus electrode to be described below.

In the electrochromic device according to the present invention, the first and second transparent electrodes have a predetermined area, and at least a part of an upper surface of a first transparent electrode 110a and at least a part of a lower surface of a second transparent electrode 110b face each other.

The transparent electrode transfers electric charge to an electrochromic material positioned between the transparent electrodes, so that the electrochromic material is oxidized or reduced. When the area of the transparent electrode is less than a certain area, the electrochromic materials spreading between the two transparent electrodes almost simultaneously receive electric charge from the transparent electrodes, and the color is almost simultaneously changed.

However, when the area of the transparent electrode is equal to or larger than a certain area, there is a large difference in the time for receiving electric charge from the transparent electrodes depending on the position of the electrochromic material. Accordingly, the time for color change of the electrochromic material is visibly changed depending on the position thereof.

The present invention includes first and second transparent electrodes, a first bus electrode 120, an electrolyte layer 130, an electrochromic layer 140, and a passivation layer 150 in order to improve the color changing speed of an electrochromic material positioned between two transparent electrodes.

For the convenience of description, the constituent elements included in FIG. 1 will be first described, but the electrochromic device according to the present invention may include other constituent elements in addition to the above constituent elements. This will be described with reference to the accompanying other drawings.

The first bus electrode 120 is formed on an upper surface of the first transparent electrode 110a. In the present specification, the formation on the upper surface of the first transparent electrode 110a means that the corresponding constituent element comes in contact with the upper surface of the first transparent electrode 110a. However, exceptionally, a passivation layer may be formed between the first transparent electrode 110a and the first bus electrode 110a, but this will be described below. That is, unless otherwise mentioned, in the present specification, the first bus electrode 120 comes in contact with the upper surface of the first transparent electrode 110a.

Meanwhile, the first bus electrode 120 may be formed in a predetermined pattern. Here, the predetermined pattern means a pattern of the first bus electrode 120 formed on the upper surface of the first transparent electrode 110a. For example, the first bus electrode 120 may be formed in a grid pattern on the upper surface of the first transparent electrode 110a. The pattern that the first bus electrode may have will be described below in FIGS. 12 and 13.

Meanwhile, the first bus electrode 120 may be formed of a material having higher conductivity than the above-described transparent electrode. Specifically, the first bus electrode may be formed of any one of a metal, a conductive polymer, and a conductive carbon nanotube, and particularly, may be formed of silver, gold, platinum, and the like having high conductivity. Through this, the first bus electrode 120 may transfer electric charge to the electrochromic layer more rapidly than the transparent electrode.

When voltage is applied between the first and second transparent electrodes, the electrolyte layer 130 transfers the electric charge between the two electrodes to the electrochromic layer 140, and may be formed of a liquid-phase, quasi solid-phase, or solid-phase electrolyte.

Since the electrolyte used for the electrolyte layer 130 is a material used for the electrochromic device in the related art, a detailed description on the material forming the electrolyte layer will be omitted.

Meanwhile, the electrolyte layer 130 may be positioned between the first bus electrode 120 and the second transparent electrode 110b. Here, the electrolyte layer does not come in contact with the first bus electrode 120, and the electrochromic layer 140 may be formed in a space between the electrolyte layer 130 and the first bus electrode 120.

Further, the electrolyte layer 130 may or may not come in contact with the second transparent electrode 110b. When the electrolyte layer 130 does not come in contact with the second transparent electrode 110b, another layer may be positioned between the electrolyte layer 130 and the second transparent electrode 110b. This will be described below.

The electrochromic layer 140 (or the first electrochromic layer) may be formed of an electrochromic material. Here, the electrochromic material is a material that is colored or decolorized by an electrochemical oxidation or reduction reaction.

The electrochromic material forming the first electrochromic layer 140 is not limited to a specific material, and may be any material which is oxidized or reduced between the first and second transparent electrodes and may change color.

The first electrochromic layer 140 is positioned between the first transparent electrode 110a and the electrolyte layer 130, and comes in contact with the electrolyte layer 130. The electrolyte layer 130 allows the electrochromic material included in the first electrochromic layer 140 to be oxidized or reduced by transferring electric charge to the first electrochromic layer 140.

When the electrochromic material repeats oxidation or reduction, the first bus electrode 120 adjacent to the first electrochromic layer 140 may be oxidized, and accordingly, the charge transfer capability of the first bus electrode 120 may deteriorate.

In order to solve these problems, in the electrochromic device according to the present invention, the first bus electrode 120 and the first electrochromic layer 140 does not come in contact with each other. However, exceptionally, the first bus electrode 120 and the first electrochromic layer 140 come in contact with each other in some cases, but the cases will be described separately in FIG. 10. Unless otherwise mentioned in the present specification, the first bus electrode 120 and the first electrochromic layer 140 do not come in contact with each other.

In addition, the first bus electrode 120 formed of a metal material is shined by external light. The shining of the first bus electrode 120 interferes with the visual field of a user looking at the electrochromic device.

In order to prevent contact of the first bus electrode 120 and the first electrochromic layer 140 and to prevent the first bus electrode from shining, the electrochromic device according to an Example of the present invention includes the passivation layer 150.

The passivation layer 150 is formed between the first bus electrode 120 and the first electrochromic layer 140 so as to prevent contact of the first bus electrode 120 and the first electrochromic layer 140, and encompasses the first bus electrode 120.

Meanwhile, the passivation layer 150 may be formed of any one of an insulating material and a conductive material, depending on the manner of encompassing the first bus electrode 120. Here, the insulating material may be any one of SiO₂ and TiO₂, and the conductive material may be any one of fluorine-doped tin oxide, indium-doped tin oxide, and zinc aluminum oxide.

Specifically, as in FIG. 1, the passivation layer 150 encompasses the first bus electrode 120, but in the case of preventing contact of the first transparent electrode 110a and the first electrochromic layer 140, the passivation layer 150 is formed of an insulating material. The passivation layer 150 formed of an insulating material prevents corrosion of the first bus electrode 120. However, in this case, since the passivation layer 150 has low electric conductivity, the first bus electrode 120 usually transfers electric charge to the first electrochromic layer 140 through the first transparent electrode 110a.

Meanwhile, a case where the passivation layer 150 is formed of a conductive material will be described below in FIG. 2.

Meanwhile, the passivation layer 150 absorbs or irregularly reflects external light to prevent the first bus electrode from shining.

As described above, the electrochromic device according to the present invention includes a first bus electrode which rapidly transfers electric charge uniformly spreading throughout the electrochromic device, in order to improve the response speed of the electrochromic material. Further, the electrochromic device according to the present invention includes a passivation layer encompassing the first bus electrode so as to prevent corrosion of the first bus electrode.

Through this, the present invention may improve a color changing speed of an electrochromic material spreading over a large area, and may prevent deterioration in performance which may occur as the electrochromic device is driven for a long period of time. Furthermore, the present invention may prevent the first bus electrode from being shined by external light.

Hereinafter, various implementing examples of the electrochromic device of the present invention will be examined with reference to the accompanying drawings.

FIG. 2 is a cross-sectional view illustrating an electrochromic device including a passivation layer configured so as to prevent contact of a transparent electrode and an electrochromic layer.

As illustrated in FIG. 2, the passivation layer 150 is formed between the first transparent electrode 110a and the first electrochromic layer 140 so as to prevent contact of the first transparent electrode 110a and the first electrochromic layer 140.

In this case, the passivation layer 150 may be formed of a conductive material, and electric charge transferred from the first bus electrode 120 is usually transferred to the first electrochromic layer 140 through the passivation layer 150.

A part of the passivation layer 150 formed of a conductive material may be oxidized as the electrochromic device is driven for a long period of time, but oxidation of the first bus electrode 120 may be prevented.

As described in FIGS. 1 and 2, the passivation layer 150 may have two forms. Hereinafter, for the convenience of description, each of the forms of the passivation layer 150 described in FIGS. 1 and 2 will be referred to as ‘a first form’ and ‘a second form’.

FIG. 3 is a cross-sectional view illustrating an electrochromic device including an ion storage layer.

The electrochromic device of the present invention may further include an ion storage layer 160.

The ion storage layer 160 serves to strengthen the charge transferring power of the electrochromic device, and may be formed of a highly ion conductive inorganic material such as antimony-doped tin oxide.

The ion storage layer 160 may be positioned between the second transparent electrode 110b and the electrolyte layer 130, and may be come in contact with the second transparent electrode 110b and the electrolyte layer 130.

Meanwhile, a second bus electrode 120b different from a first bus electrode 120a may be positioned on a lower surface of the second transparent electrode 110b.

The specific description on the second bus electrode 120b will be replaced with the description on the first bus electrode 120a.

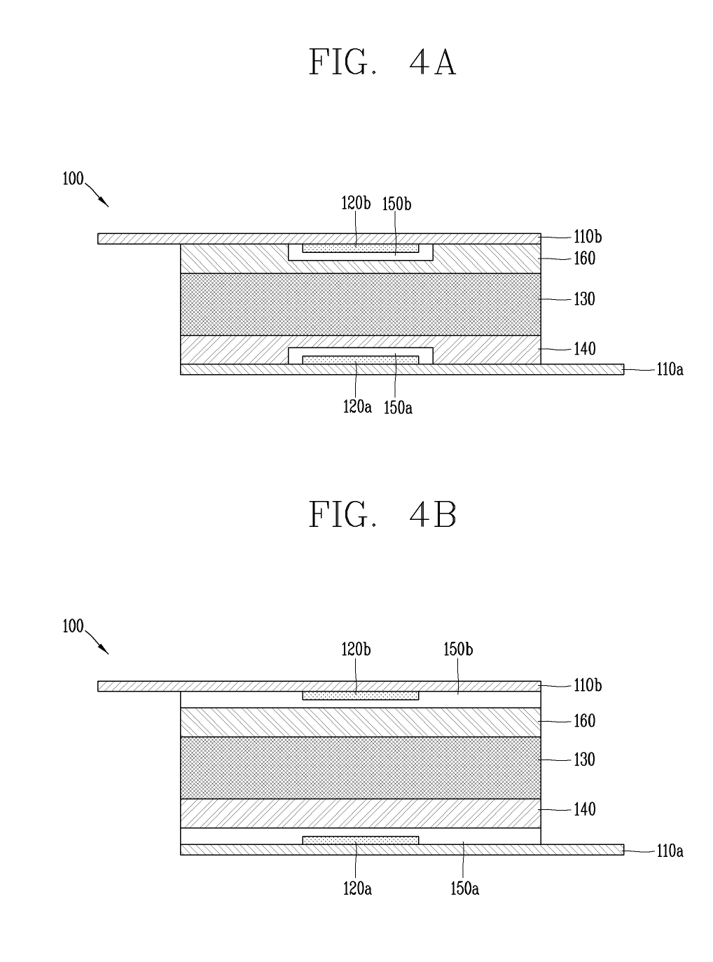

Meanwhile, when the second bus electrode 120a comes in contact with the ion storage layer 160, the second bus electrode 120a is oxidized as the electrochromic device is driven for a long period of time. In order to solve the problems, the electrochromic device according to the present invention may include a plurality of passivation layers. This will be described in FIGS. 4A and 4B.

FIGS. 4A and 4B are cross-sectional views illustrating an electrochromic device including an ion storage layer and a plurality of passivation layers.

As illustrated in FIGS. 4A and 4B, the second bus electrode 120b may be formed on a lower surface of the second transparent electrode 110b.

Meanwhile, a separate passivation layer may be formed between the second bus electrode 120b and the ion storage layer 160 so as to prevent contact of the second bus electrode 120b and the ion storage layer 160. The passivation layer 150b formed between the second bus electrode 120b and the ion storage layer 160 may be in the form of encompassing the second bus electrode 120b.

Meanwhile, as in FIG. 4A, the passivation layer 150b encompassing the second bus electrode 120b may have the first form. The passivation layer 150b having the first form may be formed of an insulating material.

Unlike the above case, as in FIG. 4B, the pessimistic layer 150b may have the second form. The passivation layer 150b having the second form may be formed of a conductive material.

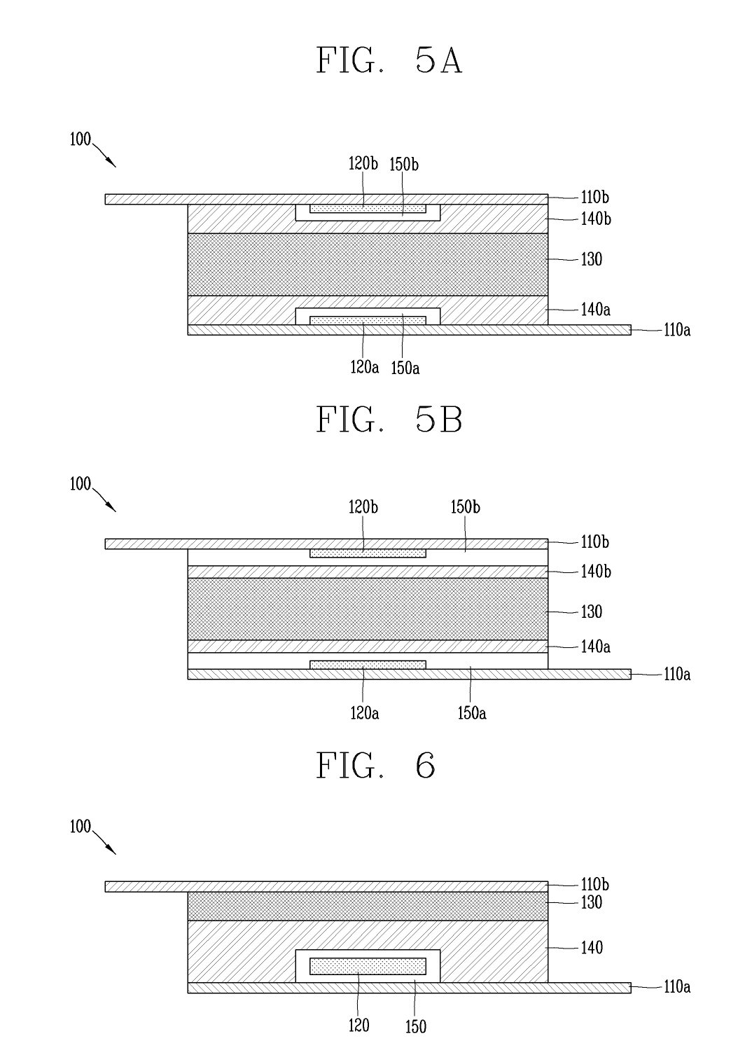

FIGS. 5A and 5B are cross-sectional views illustrating an electrochromic device including a plurality of electrochromic layers.

As illustrated in FIGS. 5A and 5B, the electrochromic device of the present invention may include two different electrochromic layers 140a and 140b.

The two electrochromic layers 140a and 140b may be formed of the same electrochromic material, or may be formed of materials different from each other. The description on the electrochromic material forming the two electrochromic layers will be replaced with the description on the electrochromic layer described in FIG. 1.

In the case of two electrochromic layers, the electrochromic device of the present invention may include two bus electrodes in order to improve the color changing speed for each electrochromic side. Specifically, the electrochromic device of the present invention may include first and second bus electrodes 120a and 120b.

As in FIGS. 5A and 5B, the first bus electrode 120a may be positioned on an upper surface of the first transparent electrode 110a, and the second bus electrode 120b may be positioned on a lower surface of the second transparent electrode 110b.

Meanwhile, the electrochromic device of the present invention may include two passivation layers 150a and 150b in order to prevent corrosion of the first and second bus electrodes and prevent the first and second bus electrodes from shining.

Specifically, one 150a of the two passivation layers is positioned between the first bus electrode 120a and the first electrochromic layer 140a, and encompasses the first bus electrode 120a.

The other passivation layer 150b is formed between the first bus electrode 120a and the first electrochromic layer 140a, and encompasses the second bus electrode 120b, so as to prevent contact of the second bus electrode 120b and the second electrochromic layer 140b.

Meanwhile, as in FIG. 5A, the two passivation layers 150a and 150b may have the first form. In this case, the two passivation layers 150a and 150b may formed of an insulating material.

Unlike the above case, as in FIG. 5B, the two passivation layers 150a and 150b may have the second form. In this case, the two passivation layers 150a and 150b may formed of a conductive material.

FIG. 6 is a cross-sectional view illustrating an electrochromic device including a passivation layer formed so as to prevent contact of a transparent electrode and a bus electrode.

As in FIG. 6, the passivation layer 150 included in the electrochromic device may be formed between the first transparent electrode 110a and the first bus electrode 120 so as to prevent contact of the first transparent electrode 110a and the first bus electrode 120.

The first bus electrode 120 includes an upper surface and a lower surface. The passivation layer described in FIG. 1 may prevent the upper surface of the first bus electrode 120 from shining, but may not prevent the lower surface of the first bus electrode 120 from shining.

The passivation layer 150 in FIG. 6 may prevent the upper surface and the lower surface of the first bus electrode 120 from shining.

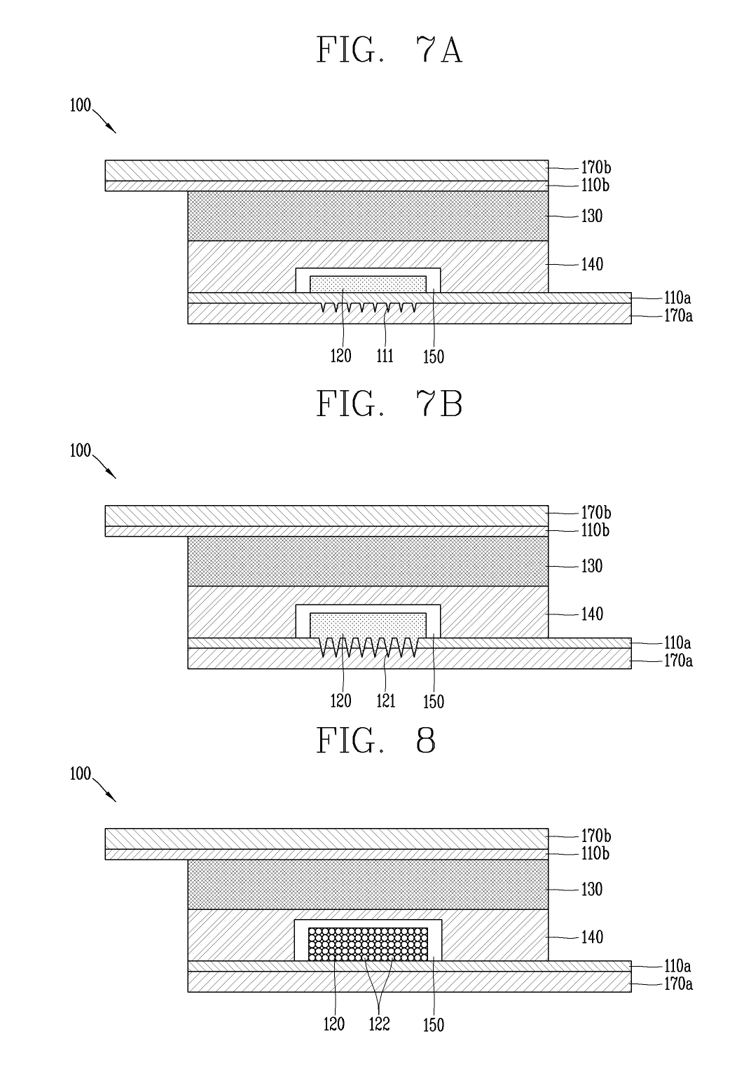

FIGS. 7A and 7B are cross-sectional views illustrating an electrochromic device having an irregularity structure.

The electrochromic device of the present invention may include a structure different from that in FIG. 6, in order to prevent the lower surface of the first bus electrode 120 from shining.

As in FIG. 7A, the first transparent electrode 110a forms irregularities 111 in a region in which the first transparent electrode 110a and the first bus electrode 120 come in contact with each other. In this case, the irregularities 111 may be formed on the lower surface of the first transparent electrode 110a.

The irregularities 111 may be formed by grooves produced on the upper surface of the substrate when the electrochromic device is manufactured. Specifically, the first transparent electrode 110a may be laminated in the form of a thin film on the upper surface of a first substrate 170a, but when grooves are made on the upper surface of the first substrate 170a before laminating the first transparent electrode 110a, the space between the grooves are filled with a material forming the first transparent electrode 110a. Accordingly, irregularities are formed on the lower surface of the first transparent electrode 110a.

Unlike the above case, as in FIG. 7B, irregularities 121 are formed in a region in which the first transparent electrode 110a and the first bus electrode 120 come in contact with each other. In this case, the irregularities 121 may be formed on the lower surface of the first bus electrode 120.

The irregularities 121 may be formed by grooves produced on the first substrate 110a when the electrochromic device is manufactured. Specifically, the first bus electrode 120 may be laminated in the form of a thin film on the upper surface of a first transparent electrode 110a, but when grooves are made on the upper surface of the first transparent electrode 110a before laminating the first bus electrode 120, the space between the grooves are filled with a material forming the first bus electrode 120. Accordingly, irregularities are formed on the lower surface of the first bus electrode 120.

The irregularities 111 and 121 described in FIGS. 7A and 7B may prevent the lower surface of the first bus electrode from shining.

FIG. 8 is a cross-sectional view illustrating an electrochromic device including a bus electrode formed of spherical nanoparticles.

The electrochromic device of the present invention may include the first bus electrode 120 formed of spherical nanoparticles 122 in order to prevent the upper surface and the lower surface of the first bus electrode from shining. Here, the nanoparticles 122 may be formed of a material which is the same as that of the first bus electrode 120 described in FIG. 1.

The nanoparticles 122 illustrated in FIG. 8 are illustrated to be larger than the actual size for the convenience of description, and the particle diameter of the nanoparticles 122 constituting the first bus electrode is 10 nm to 500 nm.

The nanoparticles 122 scatter external light to prevent the first bus electrode 120 from shining.

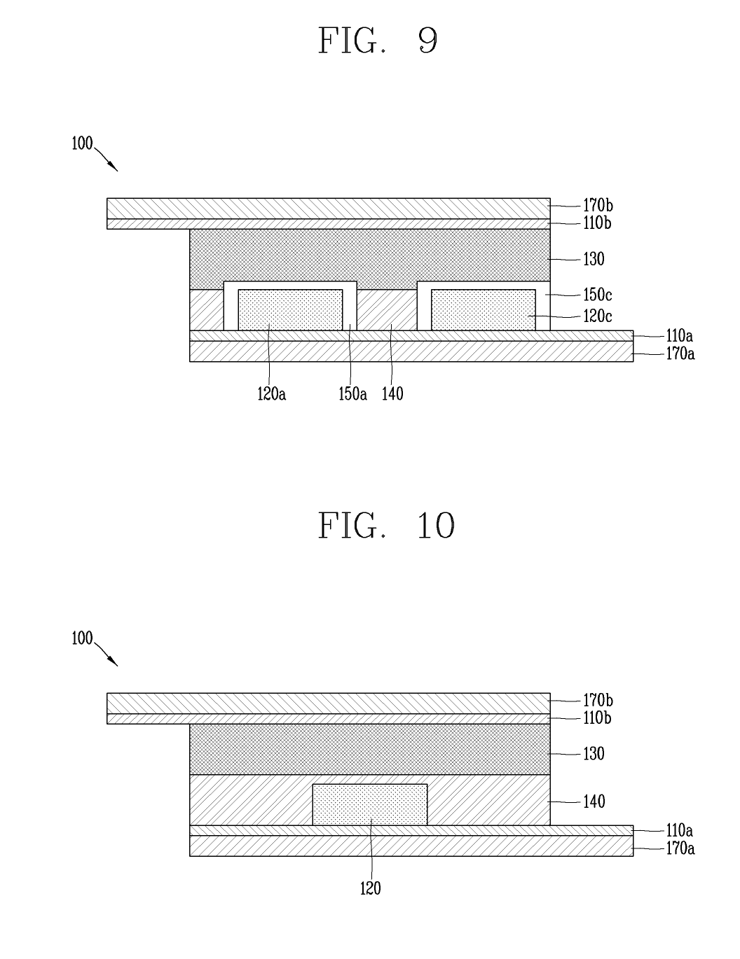

FIG. 9 is a cross-sectional view illustrating an electrochromic device including a bus electrode forming a partition wall.

The first bus electrode 120 may be configured so as to three-dimensionally supply electric charge to the electrochromic layer 140.

As in FIG. 9, the first bus electrodes 120a and 120c come in contact with the upper surface of the first transparent electrode 110a, and form a plurality of partition walls. The first electrochromic layer 140 may be positioned between the partition walls formed by the first bus electrodes 120a and 120c.

Meanwhile, as in FIG. 9, the first bus electrodes 120a and 120c may be formed at the same height as the first electrochromic layer 140. Accordingly, the passivation layers 150a and 150c come in contact with the electrolyte layer. That is, the first electrochromic layer 140 is not positioned between the upper surface of the passivation layers 150a and 150c and the lower surface of the electrolyte surface 130.

Here, the heights of the first bus electrodes 120a and 120c may be 5 μm to 100 μm. That is, the height of the partition wall may be 5 μm to 100 μm.

Through this, the first bus electrodes 120a and 120c and the first transparent electrode 110a may three-dimensionally supply electric charge to the first electrochromic layer 140. Accordingly, the color changing speed of the first electrochromic layer 140 may be improved.

FIG. 10 is a cross-sectional view illustrating an electrochromic device including a bus electrode formed of a mixture of metal and conductive ink.

The electrochromic device according to an Example of the present invention may not include a passivation layer.

Specifically, as illustrated in FIG. 10, the electrochromic device includes the first transparent electrode 110a, the second transparent electrode 110b facing the first transparent electrode 110a, the bus electrode 120 of a predetermined pattern formed on an upper surface of the first transparent electrode 110a, the electrolyte layer 130 positioned between the first bus electrode 120 and the second transparent electrode, and the electrochromic layer 140 positioned between the first transparent electrode 110a and the electrolyte layer 130 and coming in contact with the electrolyte layer 130.

The electrochromic device described in FIG. 10 does not include the passivation layer described in FIG. 1. Accordingly, the first bus electrode 120 included in the electrochromic device described in FIG. 10 is highly likely to be oxidized.

In order to solve these problems, the first bus electrode 120 illustrated in FIG. 10 is formed of a mixture of metal and conductive ink. Here, the conductive ink may be conductive carbon black.

The conductive ink suppresses the oxidation of a metal constituting the first bus electrode 120, and improves the absorbance of the first bus electrode 120 to prevent the first bus electrode 120 from shining.

Meanwhile, a plurality of layers for protecting the electrochromic device may be formed.

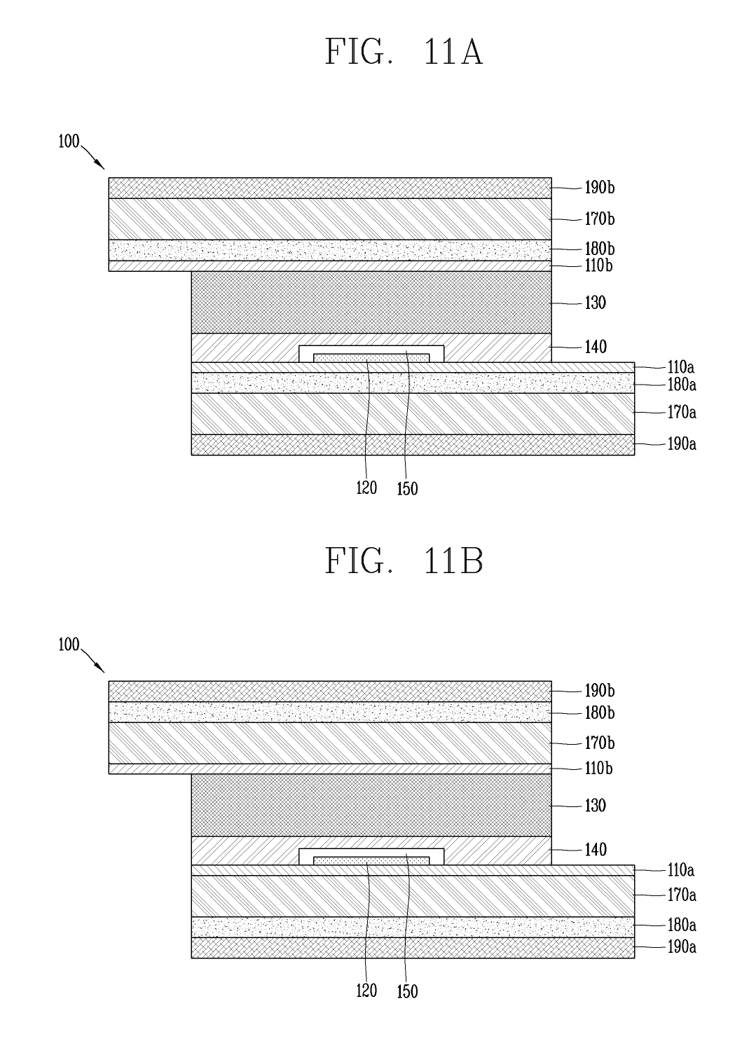

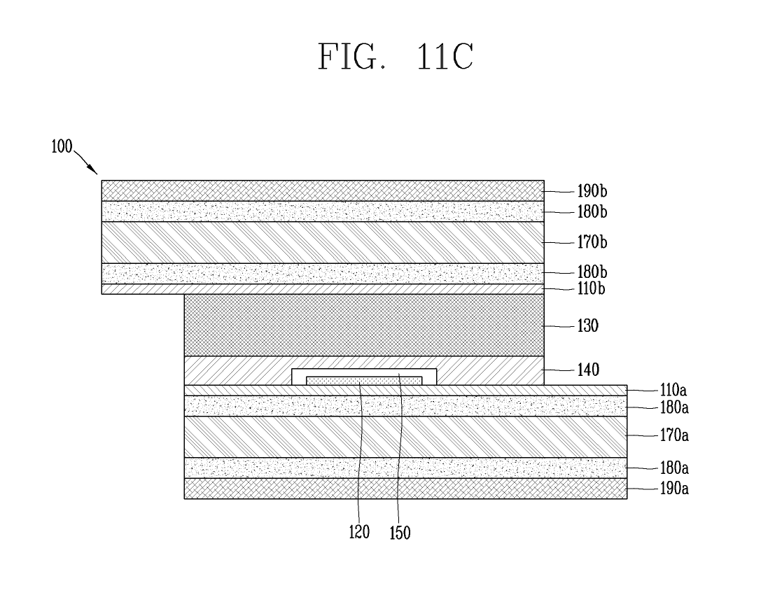

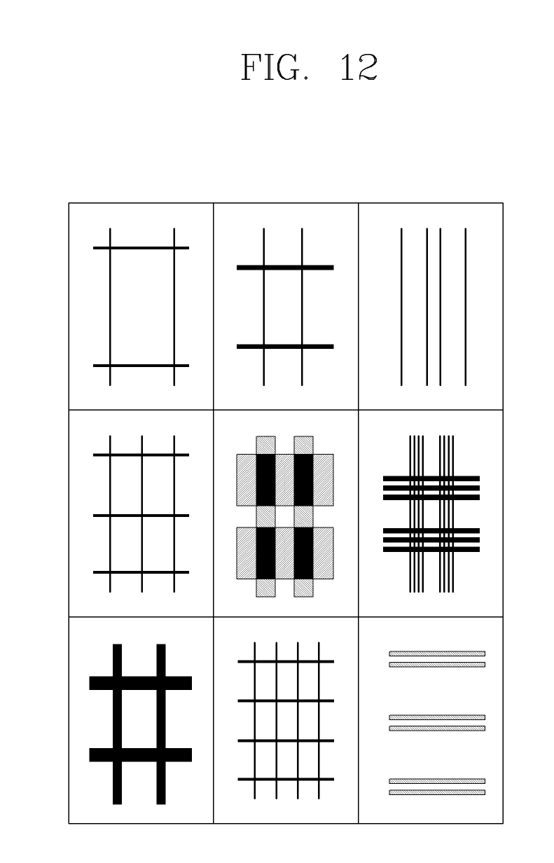

FIGS. 11A to 11C are cross-sectional views illustrating an electrochromic device including a barrier layer and a hard coating layer.

As in FIG. 11A, the electrochromic device according to an Example of the present invention may further include barrier layers 180a and 180b disposed between a transparent electrode and a substrate and hard coating layers 190a and 190b covering the substrate.

The barrier layer is used in order to prevent penetration of moisture and the like into the transparent electrode.

Meanwhile, the hard coating layer may be disposed on the outermost shell of the electrochromic device and may be selectively used, if necessary because the hard coating layer is not an essential constituent element of the electrochromic device.

Meanwhile, the barrier layers 180a and 180b may be disposed between the hard coating layer and the substrate as in FIG. 11B, and may be disposed between the substrate and the transparent electrode and between the hard coating layer and the substrate as in FIG. 11C. That is, a plurality of barrier layers may be disposed at one electrochromic device.

Meanwhile, the bus electrode described in FIGS. 1 to 11C may be formed with various patterns.

FIGS. 12 and 13 are conceptual views illustrating a pattern of a bus electrode included in the electrochromic device according to the present invention.

The bus electrode may be formed on the upper surface or lower surface of the transparent electrode with the pattern illustrated in FIG. 12. However, the bus electrode is not limited to the pattern illustrated in FIG. 12, and may be implemented in various forms.

When the bus electrode is formed with a predetermined pattern on one surface of the transparent electrode, the electrochromic device is seen in the same shape as in FIG. 13. As illustrated in FIG. 13, the electrochromic device according to the present invention forms a certain pattern by the bus electrode. The electrochromic device according to the present invention may minimize heterogeneity caused by the pattern.

Hereinafter, an electrochromic system according to an Example of the present invention will be described. The electrochromic device according to the present invention includes an electrochromic unit 310, a sensing unit 320, and a control unit 330. Hereinafter, the constituent elements will be described.

The electrochromic unit 310 is composed of an electrochromic device. The electrochromic device may constitute at least a part of a car window, and a part composed of the electrochromic device in the car window may refer to the electrochromic unit 310. Specifically, when the entire car window is composed of the electrochromic device, the entire car window may refer to the electrochromic unit 310.

The electrochromic system according to the present invention adjusts the light transmittance of the car window in each region according to the amount of light incident through the car window. For this purpose, at least a part of the car window may be composed of the electrochromic device.

Hereinafter, an electrochromic device constituting at least a part of a car window will be described.

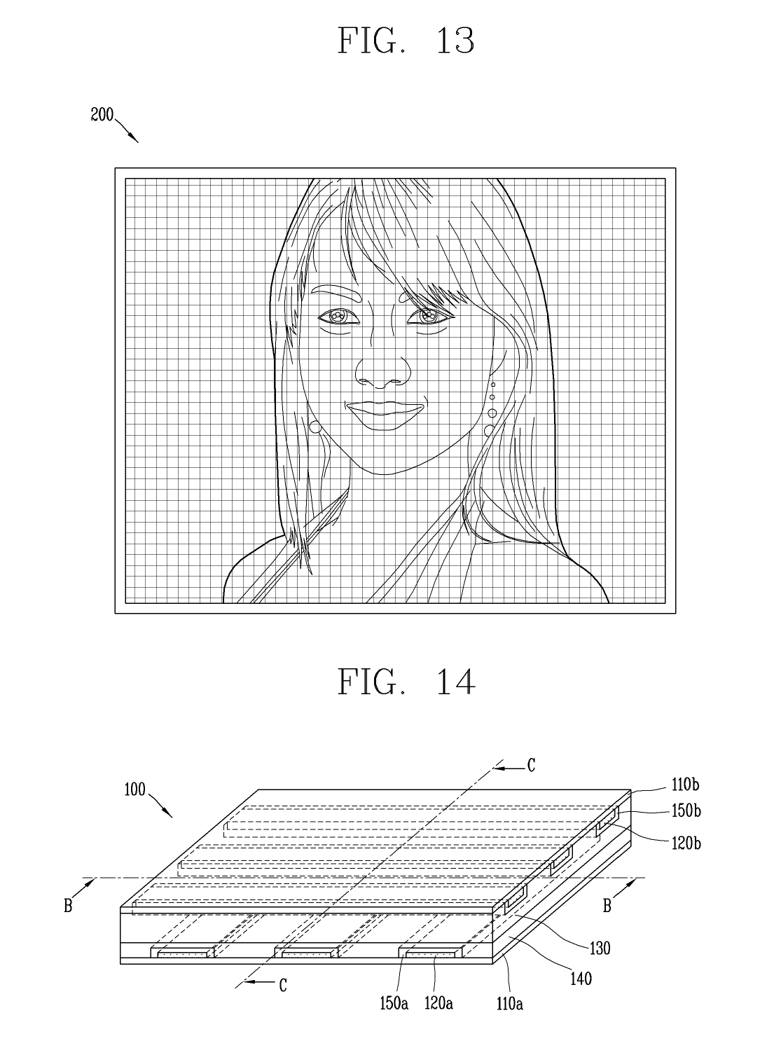

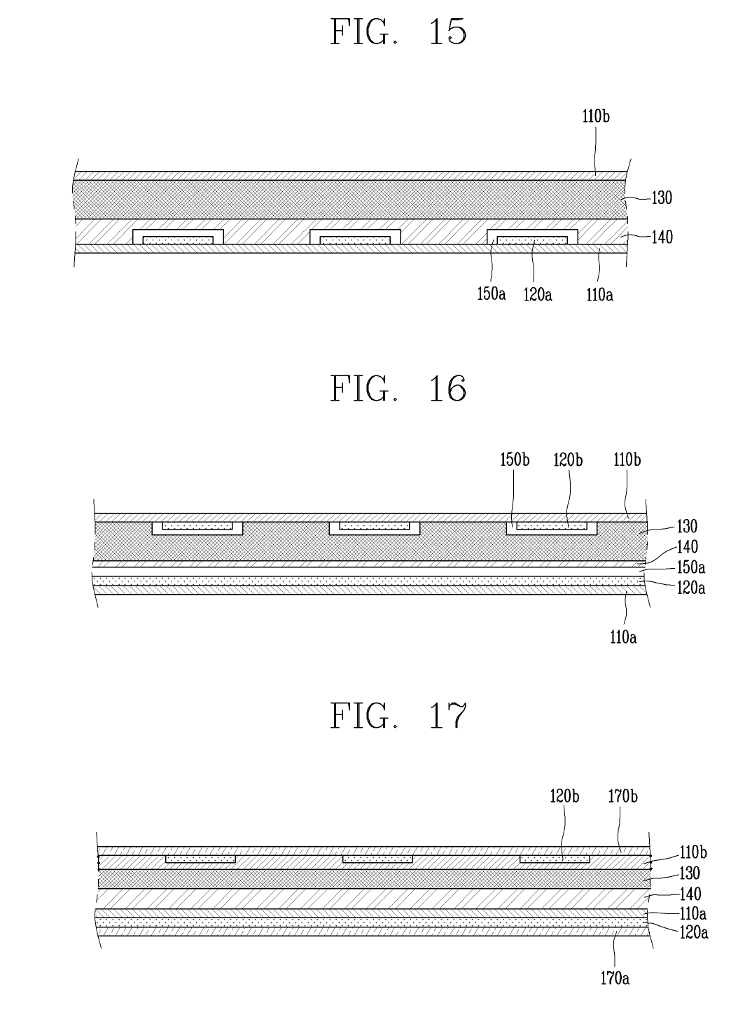

FIG. 14 is a perspective view illustrating an electrochromic device according to an Example of the present invention, FIG. 15 is a cross-sectional view taken along line B-B of FIG. 14, and FIG. 16 is a cross-sectional view taken along line C-C of FIG. 14.

According to FIG. 14, the electrochromic device according to the present invention may include the first transparent electrode 110a, the second transparent electrode 110b, the first bus electrode 120a, the second bus electrode 120b, the electrolyte layer 130, the electrochromic layer 140, the first passivation layer 150a, and the second passivation layer 150b. Further, the electrochromic device included in the electrochromic unit 310 may have the structure described in FIGS. 1 to 13.

Meanwhile, the electrochromic device according to an Example of the present invention may not include a passivation layer. Specifically, in order to reduce the thickness of the electrochromic device, the thicknesses of the respective layers included in the device need to be minimized, or the number of constituent elements included in the device needs to be minimized. For this purpose, the electrochromic device according to an Example of the present invention allows the transparent electrode to serve as a passivation layer.

FIG. 17 is a cross-sectional view of an electrochromic device which does not include a passivation layer.

FIG. 17 is a cross-sectional view of the electrochromic device taken along the C-C direction, as in FIG. 16.

The electrochromic device illustrated in FIG. 17 includes the first transparent electrode 110a, the second transparent electrode 110b, the first bus electrode 120a, the second bus electrode 120b, the electrolyte layer 130, and the first electrochromic layer 140. In addition, the constituent elements are disposed between the first substrate 170a and a second substrate 170b.

Since a material constituting the above-described constituent elements is the same as that constituting the constituent elements described in FIGS. 1 to 13, the detailed description thereof will be omitted. Hereinafter, the connection relationship of the respective constituent elements will be described.

A plurality of the first bus electrodes 120a may be disposed at a predetermined distance, and the second bus electrode 120b may be disposed so as to intersect with the longitudinal direction of the first bus electrodes 120a.

The first bus electrode 120a may be mounted inside the first transparent electrode 120a disposed on the first substrate 170a, and may be disposed between the first substrate 170a and the first transparent electrode 120a, as in FIG. 17. Accordingly, the first bus electrode 120a does not come in contact with the electrochromic layer 140 disposed on the first transparent electrode 120a.

The second bus electrode 120b may be mounted inside the second transparent electrode 120b disposed on the second substrate 170b, and may be disposed between the second substrate 170b and the second transparent electrode 120b, as in FIG. 17. Accordingly, the second bus electrode 120b does not come in contact with the electrolyte layer 130 disposed below the second transparent electrode 120b.

Meanwhile, the above-described electrochromic device which does not include the passivation layer may further include a bonding layer.

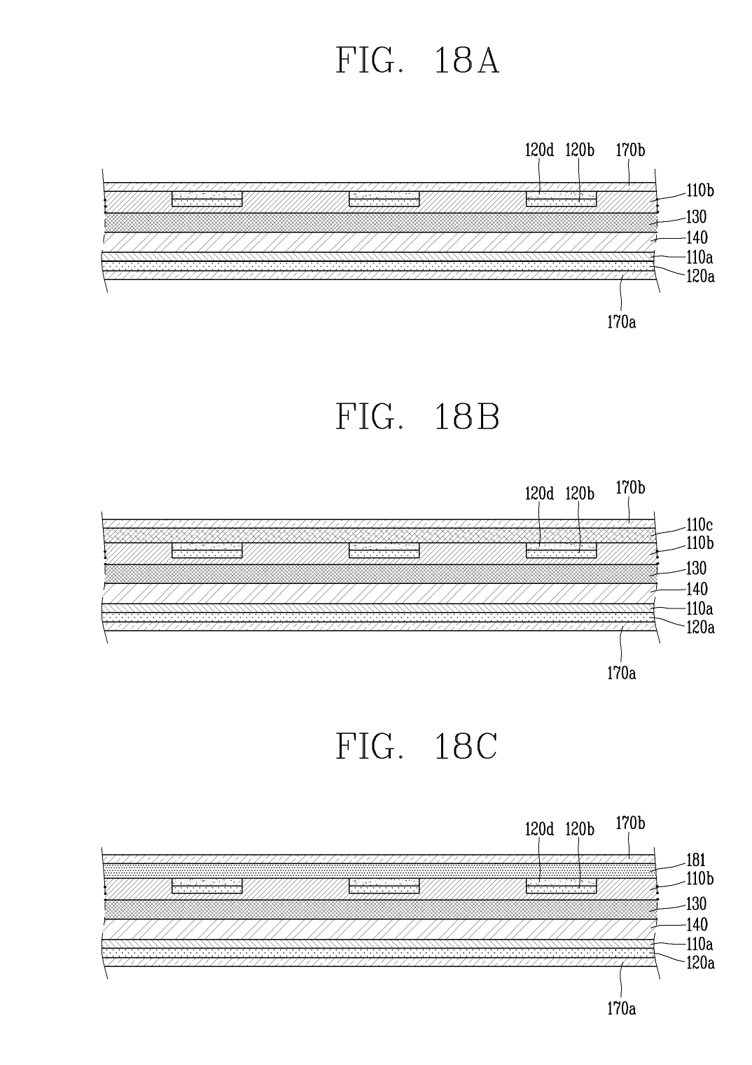

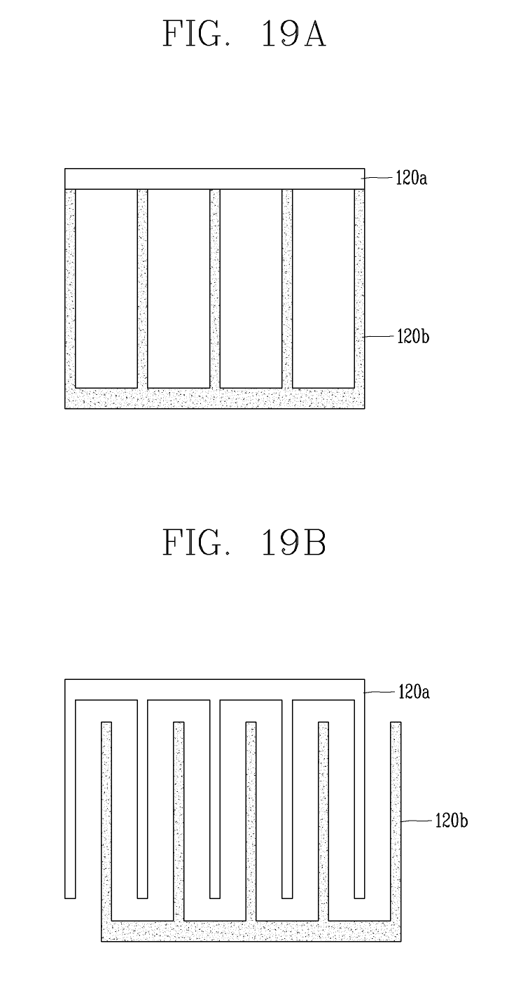

FIGS. 18A to 18C are cross-sectional views of an electrochromic device including a bonding layer.

Referring to FIG. 18A, the electrochromic device according to the present invention may further include a bonding layer 120d. Specifically, as described in FIG. 17, the bus electrode may be disposed between the transparent electrode and the substrate, and in this case, the bonding layer 120d may be disposed between the bus electrode and the substrate.

The bonding layer 120d improves the bonding force between the bus electrode and the substrate and reduces the glare generated by the bus electrode. Further, the bonding layer 120d reduces the heterogeneity that the user may feel due to the bus electrode. For this purpose, the bonding layer 120d may be configured to include black or white ink.

Meanwhile, the bonding layer 120d may be formed of a conductive material so as to compensate for the electric conductivity of the bus electrode. For example, the bonding layer 120d may be composed to include conductive carbon black.

In contrast, the bonding layer 120d may be formed of an insulating material so as to prevent oxidation of the bus electrode. For example, the bonding layer 120d may be composed to include the above-described material constituting the passivation layer.

Meanwhile, the electrochromic device described in FIG. 18A may be prepared by two different methods.

First, after the bonding layer 120d is laminated on a substrate, the bus electrode 120b is laminated on the laminated bonding line 120d. The transparent electrode 110b is laminated on the laminated bus electrode 120b. Accordingly, the bus electrode and the bonding layer are positioned between the substrate and the transparent electrode.

Second, after one surface of the transparent electrode 110b is etched, the bus electrode 120b and the bonding layer 120d are sequentially laminated at the etched position. In this case, the bus electrode and the bonding layer may be laminated by any one of sputtering, evaporation, chemical vapor deposition, and atomic layer deposition.

Meanwhile, in the above-described electrochromic element which does not include the passivation layer, the transparent electrode may be formed so as to encompass the bus electrode and the bonding layer. Referring to FIG. 18B, the transparent electrode may be composed of two layers 110b and 110c. In this case, the bonding layer 120d does not come in contact with the substrate 170b.

Meanwhile, in the above-described electrochromic device which does not include the passivation layer, a moisture permeation preventing layer 181 may be additionally disposed between the substrate and the bonding layer. The moisture permeation preventive layer 181 prevents external substances from flowing into the bus electrode, and may be formed of the same material as the barrier layer 180.

As described above, the electrochromic device according to the present invention may not include a passivation layer. The structures described in FIGS. 17 to 18C may be utilized in the case where the thickness of the device needs to be reduced, or in the case where the preparation process needs to be simplified.

Meanwhile, as described in FIG. 4A, the electrochromic device according to the present invention may include the first and second bus electrodes 120a and 120b. A plurality of bus electrodes inside the electrochromic device may be disposed in various patterns.

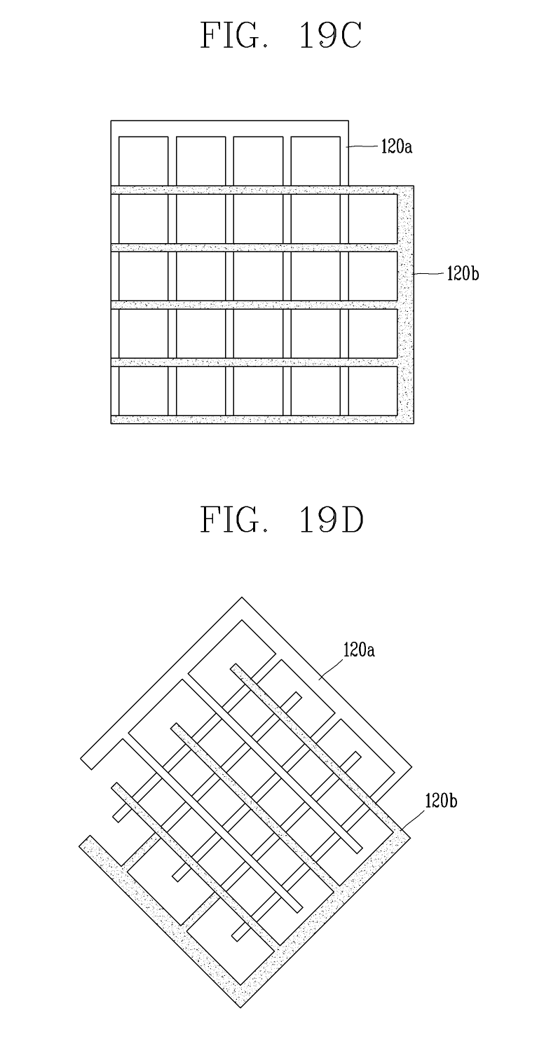

FIGS. 19A to 19D are conceptual views illustrating a pattern of a bus electrode included in the electrochromic device according to the present invention.

First, referring to FIGS. 19A and 19B, the first and second bus electrodes 120a and 120b may be disposed horizontally to each other. Specifically, as in FIG. 19A, the first and second bus electrodes 120a and 120b may be disposed so as to face each other, and as in FIG. 19B, the first and second bus electrodes 120a and 120b may be disposed to intersect with each other.

Meanwhile, referring to FIGS. 19C and 19D, the first and second bus electrodes 120a and 120b may be disposed perpendicular to each other. Specifically, as in FIG. 19C, one of the first and second bus electrodes 120a and 120b may be positioned at the upper portion of the electrochromic device, and the other may be positioned at the lower portion of the electrochromic device. In contrast, referring to FIG. 19D, each of the first and second bus electrodes 120a and 120b may alternately be positioned at the upper portion and lower portion of the electrochromic device.

Hereinafter, a change in light transmittance of the above-described electrochromic device will be described.

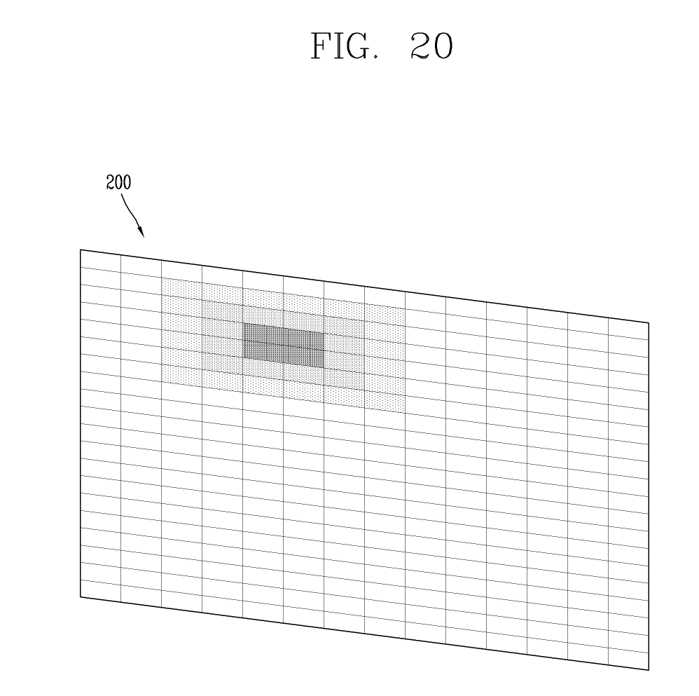

FIG. 20 is a conceptual view illustrating a change in light transmittance of the electrochromic device according to the present invention.

When a voltage equal to or higher than the reference voltage is applied to a part of the electrochromic layer 140, the part is converted from the first state to the second state. Meanwhile, when a reverse voltage equal to or higher than the reference voltage is applied to the part of the second state, the part is converted from the second state to the first state.

In this case, the light transmittance in the first state is higher than the light transmittance in the second state. That is, when the electrochromic layer 140 undergoes electrochromism, the light transmittance is increased or decreased.

The first and second bus electrodes may be utilized in order to apply a voltage equal to or higher than the reference value to a part of the electrochromic layer 140. Hereinafter, a method of changing the light transmittance of a part of the electrochromic layer 140 will be described by taking the electrochromic device illustrated in FIG. 20 as an example.

A plurality of horizontal lines and vertical lines illustrated in FIG. 20 are the first and second bus electrodes described in FIGS. 14 to 18C. For the convenience of description, the horizontal lines and vertical lines illustrated in FIG. 20 refer to a first bus electrode and a second bus electrode, respectively. That is, the electrochromic device 200 illustrated in FIG. 20 includes 19 first bus electrodes and 13 second bus electrodes. Further, bus electrodes are described in order from left to right or top to bottom.

For example, when a voltage equal to or higher than the reference value is applied between the fourth first bus electrode and the fifth second bus electrode, electrochromism occurs in the electrochromic layer. Specifically, electrochromism occurs sequentially from a region close to a point where the fourth first bus electrode and the fifth second bus electrode in the entire region of the electrochromic layer intersect with each other.

For another example, although not illustrated, when a voltage equal to or higher than the reference value is applied between the fourth and tenth first bus electrodes and the fifth second bus electrode, electrochromism occurs sequentially from a region close to a point where the fourth and tenth first bus electrodes and the fifth second bus electrode in the entire region of the electrochromic layer intersect with each other. That is, different regions of the electrochromic layer may simultaneously undergo electrochromism.

In the electrochromic system according to the present invention, the light transmittance of a part of the electrochromic element is controlled by the above-mentioned method. A more detailed description will be given below, together with a description on the control unit.

Meanwhile, bus electrodes may be irregularly disposed in the electrochromic device according to an Example of the present invention.

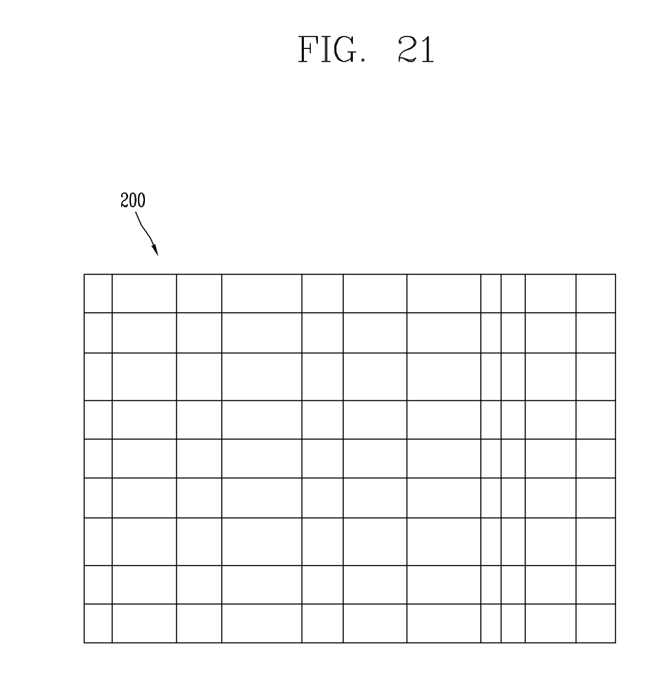

FIG. 21 is a conceptual view illustrating an electrochromic device in which bus electrodes are irregularly disposed.

For the convenience of description, the horizontal lines and vertical lines illustrated in FIG. 21 refer to a first bus electrode and a second bus electrode, respectively. According to FIG. 21, the first bus electrodes may be disposed at regular intervals, and the second bus electrodes may be disposed at irregular intervals. When all the bus electrodes are disposed at regular intervals, Moire may occur, which may interfere with the visual field of a driver. In order to prevent such a phenomenon, a part of the bus electrodes included in the electrochromic device may be irregularly disposed.

Hereinafter, a sensing unit 320 will be described.

The sensing unit is configured so as to sense the amount of light incident to the electrochromic unit 310. Specifically, the light transmission amount may vary in each region of the electrochromic unit 310 by external light. For example, when the entire window of a vehicle is entirely composed of the electrochromic unit 310, the light transmission amount to a part of the electrochromic unit 310 may be increased by the front lamp of another vehicle approaching the front of the vehicle. The sensing unit 320 senses the light transmission amount distribution of the electrochromic unit 310 in each region.

More specifically, the light transmission amount distribution for the electrochromic unit 310 may be sensed one-dimensionally or two-dimensionally, and the sensing unit 320 may be positioned near the driver's eyes. In association with the position of the sensing unit 320, the sensing unit 320 may be disposed at a position where advanced driver assistance systems (ADAS) or a black box are or is attached, or may be disposed on the front window surface of a vehicle, and the like. In addition, the position of the sensing unit 320 is not limited to the inside of the vehicle.

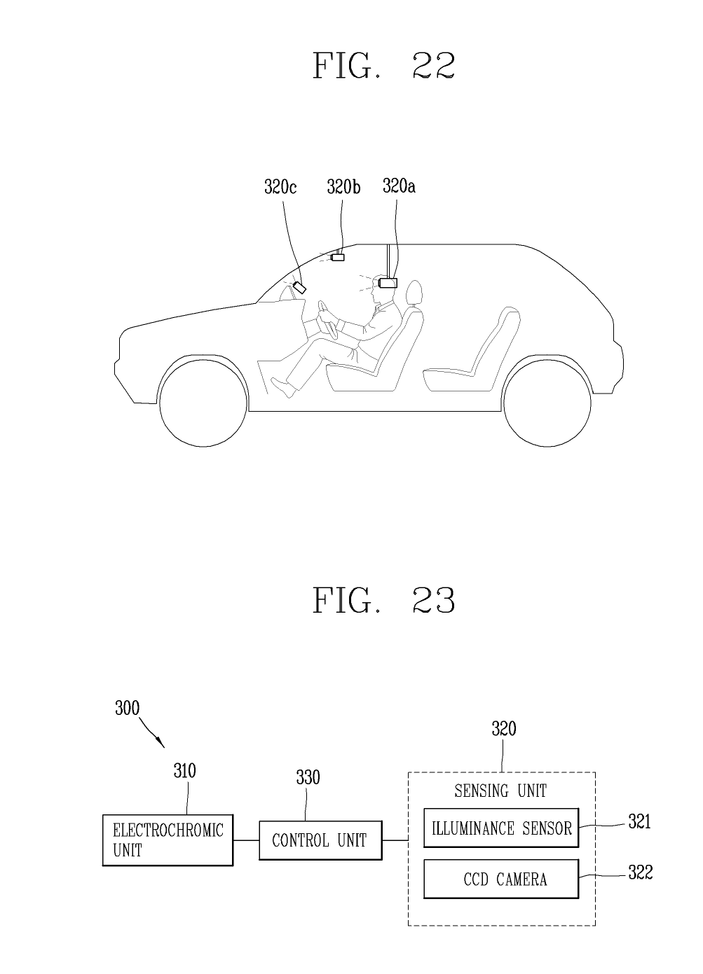

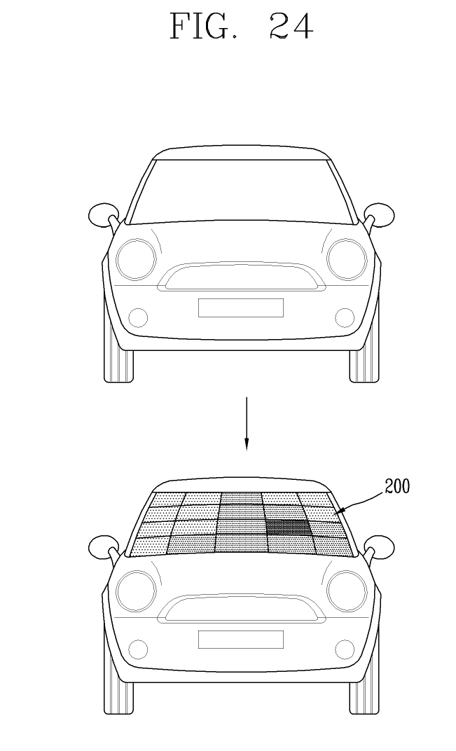

As in FIG. 22, the sensing unit 320 may be positioned at a position 320a near the driver's eyes, disposed at a position 320b where a black box or the like is attached, or disposed on the surface 320c of the window. In this case, the amount of light sensed from the sensing unit 320 may be corrected so as to correspond to the positions of the driver's eyes, and the light transmittance of the electrochromic unit 310 may be controlled by the corrected amount of light. Specifically, even though the amount of light actually incident to the electrochromic unit 310 is large, when light is incident to a place where the driver's eyes are not positioned, the corrected amount of light may be actually less than the amount of light actually incident.

The sensing unit 320 may include an illuminance sensor or a CCD camera.

The illuminance sensor may be disposed so as to form a plurality of arrays, and each of the plurality of illuminance sensors is arranged in a different direction from each other, and thus may sense a direction in which light is incident. Through this, the present invention may control the electrochromic unit 310 such that when the direction in which light is incident does not go toward a driver, the light transmittance is not changed even though the amount of light incident is increased.

Meanwhile, the sensing unit 320 may include image equipment already mounted on a vehicle. For example, the sensing unit 320 may include a CCD camera included in a black box already mounted on a vehicle. Specifically, the present invention may calculate the amount of light incident to the electrochromic unit 310 by using the images captured through the CCD camera. For example, the present invention recognizes an object (the sun, a headlight) corresponding to a light source among the above-mentioned images, and thus may control the light transmittance of the electrochromic unit 310 in a region corresponding to the light source in the entire region.

For another example, the present invention may divide the image into the virtual regions and calculate the brightness for each region. After that, the present invention may control the light transmittance of the electrochromic unit 310 based on the calculated brightness.

Through this, the electrochromic system according to the present invention may sense the amount of light incident to the electrochromic unit 310 without having to install additional equipment in a vehicle.

Meanwhile, the sensing unit 320 may calculate the amount of light incident to the electrochromic unit 310 through heat sensing. For example, the sensing unit 320 may include a thermal imaging camera. The present invention may control the light transmittance of the electrochromic unit 310 according to the temperature of the electrochromic unit 310 by using the images captured by the thermal imaging camera.

Hereinafter, a control unit 330 will be described.

When the amount of light incident through a partial region of the electrochromic unit 310 is changed, the control unit 330 controls the electrochromic unit 310 such that the light transmittance for the partial region is changed.

The control unit 330 may divide the electrochromic unit 310 into a plurality of regions. Here, the plurality of regions may be physically partitioned regions and may be regions partitioned into virtual partitions. For example, the control unit 330 may partition virtual regions based on a plurality of points where the first and second bus electrodes intersect with each other.

The control unit 330 may calculate the amount of light incident through each of the plurality of regions by using a sensing value sensed from the sensing unit 320. Meanwhile, when the sensing unit 320 includes image equipment, the control unit 330 may calculate the amount of light incident through each of the plurality of regions by using the images received from the image equipment.

Meanwhile, the sensing unit 330 may calculate the amount of light incident to the electrochromic unit 310 in consideration of the driver's gaze direction. For this purpose, the present invention may further include a separate sensor which senses the driver's gaze direction.

For example, the present invention may further include an eye tracking sensor. Here, the eye tracking sensor is a sensor that tracks a person's eyeballs and senses where the person's gaze is staying.

The control unit 330 may calculate the amount of light that can reach the driver's eyes based on the driver's gaze direction. The control unit 330 may control the light transmittance of the electrochromic unit 310 based on the amount of light reaching the driver's eyes.

For example, the control unit 330 may control the electrochromic unit 310 such that the light transmittance of a region corresponding to the driver's gaze direction in the entire region of the electrochromic unit 310 is changed preferentially over the light transmittances of the other regions.

For another example, when it is determined that the driver's gaze does not remain in the partial region even though the amount of light amount incident to a partial region of the electrochromic unit 310 exceeds the reference value, the control unit 330 may not change the light transmittance of the partial region.

When the amount of light incident through the partial region is changed, the control unit 330 controls the electrochromic unit 310 such that the light transmittance for the partial region is changed. Here, the control unit 330 controls the electrochromic unit 310 such that the light transmittance of the partial region is decreased when the amount of light incident through the partial region becomes larger than the reference value, and controls the electrochromic unit 310 such that the light transmittance of the partial region is decreased when the amount of light passing through the partial region becomes smaller than the reference value.

Meanwhile, the control unit 310 controls a voltage value applied to each of a plurality of electrodes included in the electrochromic unit 310 such that the light transmittance of the partial region is changed. Specifically, the control unit 310 allows the potential difference between any one of the first bus electrodes 120a and any one of the second bus electrodes 120b to become the reference voltage or more. In this case, the light transmittance is sequentially changed from a point where any one of the first bus electrodes and any one of the second bus electrodes intersect with each other.

However, when a certain time passes in a state where a potential difference between any one of the first bus electrodes 120a and any one of the second bus electrodes 120b is equal to or higher than the reference voltage, the entire light transmittance of the electrochromic unit 310 may be changed while electric charge is transferred to the entire electrochromic unit 310.

In order to solve these problems, the control unit 330 controls the electrochromic unit 310 such that the light transmittance for the remaining region of the electrochromic unit 310 except for the partial region is maintained.

Taking the electrochromic device 200 illustrated in FIG. 20 as an example, the control unit 330 controls the electrochromic unit 310 such that the potential difference between the fourth first bus electrode and the fifth second bus electrode becomes the reference voltage or more. At the same time, the control unit 310 applies the reverse voltage of the reference voltage between the tenth first bus electrode and the tenth second bus electrode. Accordingly, the light transmittance of a region adjacent to a point where the fourth first bus electrode and the fifth second bus electrode intersect with each other changes, and the light transmittance of a region adjacent to a point where the tenth first bus electrode and the tenth second bus electrode intersect with each other is not changed.

The electrochromic system according to the present invention may change the light transmittance of a partial region in the entire region of the electrochromic unit, as in FIG. 24.

Meanwhile, the electrochromic system according to the present invention may include a power supply unit configured so as to supply power to the entire system including the electrochromic unit 310. When power supplied from the power supply unit is cut off due to an accident or the like, it may be difficult to secure the visual field of a driver.

For example, when external light passes through a bright region, the electrochromic system according to the present invention reduces the light transmittance of the electrochromic unit 310. In this state, when power supplied from the power supply unit is cut off and the vehicle enters a dark place, the driver may feel difficulty in securing the visual field.

In order to prepare for such a situation, the electrochromic system according to the present invention may further include an auxiliary power supply unit, and the control unit 330 controls the electrochromic unit 310 such that when power supplied from the power supply unit is cut off, all regions of the electrochromic layer are in the first state. That is, the control unit 330 controls the electrochromic unit 310 such that when the supply of the power is cut off, the electrochromic unit 310 may have the maximum light transmittance.

Through this, the electrochromic system according to the present invention may allow a driver to secure the visual field without any difficulty even when power supplied to the system is cut off due to an accident or the like.

It is obvious to the person skilled in the art that the present invention can be embodied in other specific forms without departing from the spirit and essential characteristics of the present invention.

Further, the aforementioned detailed description should not be interpreted as limitative in all aspects, and should be considered as illustrative. The scope of the present invention should be defined by the reasonable interpretation of the accompanying claims, and all the modifications within the equivalent scope of the present invention are included in the scope of the present invention.

1. An electrochromic device comprising: a first transparent electrode; a second transparent electrode facing the first transparent electrode; a first bus electrode of a predetermined pattern formed on an upper surface of the first transparent electrode; an electrolyte layer positioned between the first bus electrode and the second transparent electrode; a first electrochromic layer positioned between the first transparent electrode and the electrolyte layer and coming in contact with the electrolyte layer; and a passivation layer formed between the first bus electrode and the electrochromic layer so as to prevent contact of the first bus electrode and the electrochromic layer, and encompassing the first bus electrode.

2. The electrochromic device of claim 1, wherein the passivation layer is formed of an insulating material.

3. The electrochromic device of claim 2, wherein the insulating material is formed of any one of SiO₂ and TiO₂.

4. The electrochromic device of claim 1, wherein the first bus electrode is formed of any one of a metal, a conductive polymer, and a conductive carbon nanotube.

5. The electrochromic device of claim 1, wherein the passivation layer is formed between the first transparent electrode and the first electrochromic layer so as to prevent contact of the first transparent electrode and the first electrochromic layer.

6. The electrochromic device of claim 5, wherein when the passivation layer is configured so as to prevent contact of the first transparent electrode and the first electrochromic layer, the passivation layer is formed of a conductive material.

7. The electrochromic device of claim 6, wherein the conductive material is formed of any one of fluorine-doped tin oxide, indium-doped tin oxide, and zinc aluminum oxide.

8. The electrochromic device of claim 1, further comprising an ion storage layer between the electrolyte layer and the second transparent electrode.

9. An electrochromic device driving system comprising: an electrochromic unit which is composed of an electrochromic device and configured so as to change the light transmittance for at least a partial region, a sensing unit which is configured so as to sense an amount of light incident to the electrochromic unit, and a control unit which controls the electrochromic unit such that when the amount of light incident through a partial region of the electrochromic unit is changed, the light transmittance for the partial region is changed.

10. The electrochromic device driving system of claim 9, wherein the electrochromic unit comprises a plurality of electrodes, and the control unit controls a voltage value applied to each of the plurality of electrodes such that the light transmittance of the partial region is changed.

11. The electrochromic device driving system of claim 10, wherein the control unit controls the electrochromic unit such that when the amount of light incident through the partial region becomes larger than the reference value, the light transmittance of the partial region is decreased.

12. The electrochromic device driving system of claim 11, wherein the control unit controls the electrochromic unit such that when the amount of light passing through the partial region becomes larger than the reference value, the light transmittance of the partial region is increased.

13. The electrochromic device driving system of claim 9, wherein the control unit controls the electrochromic unit such that the light transmittance for the remaining region of the electrochromic unit except for the partial region is maintained.

14. The electrochromic device driving system of claim 11, wherein the electrochromic device comprises: a first transparent electrode; an electrochromic layer formed on the first transparent electrode and formed of an electrochromic material; an electrolyte layer formed on the electrochromic layer; a second transparent electrode formed on the electrolyte layer; a plurality of first bus electrodes formed between the first transparent electrode and the electrochromic layer; a first passivation layer encompassing each of the first bus electrodes, a plurality of second bus electrodes formed between the electrolyte layer and the second transparent electrode; and a second passivation layer encompassing each of the second bus electrodes.

15. The electrochromic device driving system of claim 14, wherein when a voltage equal to or higher than the reference value is applied to a part of the electrochromic layer, the part is converted from a first state to a second state, and when a reverse voltage equal to or higher than the reference voltage is applied to the part of the second state, the part is converted from the second state to the first state, and the light transmittance in the first state is higher than the light transmittance in the second state.

16. The electrochromic device driving system of claim 15, wherein the control unit controls a voltage value applied to each of the first and second bus electrodes such that the light transmittance of the part is changed.

17. The electrochromic device driving system of claim 16 further comprising a power supply unit, wherein the control unit controls the electrochromic unit such that when power supplied from the power supply unit is cut off, all the regions of the electrochromic layer become a first state.

18. The electrochromic device driving system of claim 9, wherein the sensing unit comprises a camera configured so as to capture external images, and the control unit partitions the electrochromic unit into a plurality of virtual regions and calculates the amount of light incident through each of the plurality of regions by using images captured by the camera.

19. The electrochromic device driving system of claim 9, further comprising a sensor configured so as to sense a driver's gaze direction, wherein the control unit controls the electrochromic unit such that the light transmittance of a region corresponding to the gaze direction in the entire region of the electrochromic unit is changed preferentially over the light transmittances of the other regions.

20. The electrochromic device driving system of claim 9, wherein the control unit corrects the amount of light sensed from the sensing unit so as to correspond to the positions of a driver's eyes, and controls the electrochromic unit by using the corrected amount of light.
